(19) United States
(12) Patent Application Publication
(10) Pub. No.: US 2015/0169942 A1
(43) Pub. Date: Jun. 18, 2015

(54) TERMINAL CONFIGURATION METHOD AND TERMINAL

(71) Applicant: Huawei Technologies Co., Ltd., Shenzhen (CN)

(72) Inventors: Nan HU, Shenzhen (CN); Liangwei WANG, Shenzhen (CN)

(21) Appl. No.: 14/565,076

(22) Filed: Dec. 9, 2014

(30) Foreign Application Priority Data
Dec. 12, 2013 (CN) 201310684757.2

(51) Int. Cl. G06K 9/00; G10L 17/22; G10L 17/26

(52) U.S. Cl. CPC G06K 9/00281; G10L 17/26; G10L 17/22; G06T 2207/10004; G06T 2207/30201

(57) ABSTRACT

The present invention relates to the field of terminal technologies and provides a terminal configuration method and apparatus, where the method includes: obtaining an image that includes a facial feature of a user; extracting the facial feature of the user from the image; obtaining, according to a preset age model, an estimated age value that matches the facial feature of the user; and loading a preset user interface into the terminal according to the estimated age value. The present invention makes a user convenient to use a terminal and enhances user experience.

### CROSS-REFERENCE TO RELATED APPLICATION

This application claims priority to Chinese Patent Application No. 201310684757.2, filed on Dec. 12, 2013, which is hereby incorporated by reference in its entirety

### TECHNICAL FIELD

The present invention relates to the field of terminal technologies, and in particular, to a terminal configuration method and a terminal.

### BACKGROUND

As a terminal continuously develops, rich functions of the terminal also make a user more convenient in life.

Currently, on the market, there are many terminals targeting old people. This type of terminal displays, by using function settings, especially large fonts, icons and menus on a screen, so that old people can use the terminal conveniently.

It can be learned from the foregoing that, a terminal needs to be set to obtain the foregoing screen effects. Currently, a terminal has many functions and old people lack knowledge of using the terminal; therefore, a series of operations, such as setting a character font on a terminal, may cause inconvenience for the old people.

### SUMMARY

Embodiments of the present invention provide a terminal configuration method and a terminal, which may make a user convenient to use a terminal.

According to a first aspect, an embodiment of the present invention discloses a terminal configuration method, where the method includes:

obtaining an image that includes a facial feature of a user; extracting the facial feature of the user from the image; obtaining, according to a preconfigured age model, an estimated age value that matches the facial feature of the user; and loading a preset user interface into the terminal according to the estimated age value.

With reference to the first aspect, in a first implementation manner of the first aspect, the loading a preset user interface into the terminal according to the estimated age value includes:

obtaining, according to the estimated age value, a configuration solution that is of the preset user interface and matches the estimated age value; and

loading the preset user interface into the terminal according to the configuration solution of the preset user interface.

With reference to the first aspect and the first implementation manner of the first aspect, in a second implementation manner of the first aspect, before the extracting the facial feature of the user from the image, the method further includes:

dividing the image into blocks and performing facial detection on different blocks to determine a position of a face; and

the extracting the facial feature of the user from the image includes:

extracting the facial feature of the user from the position of the face, where the facial feature of the user is used for performing age estimation.

With reference to the first aspect, the first implementation manner of the first aspect, or the second implementation manner of the first aspect, in a third implementation manner of the first aspect, before the obtaining, according to a preset age model, an estimated age value that matches the facial feature of the user, the method further includes:

collecting a voice of the user and extracting a feature of the voice; and

the obtaining, according to a preset age model, an estimated age value that matches the facial feature of the user includes:

obtaining, according to the preset age model, an estimated age value that matches the facial feature of the user and the feature of the voice.

With reference to the first aspect, the first implementation manner of the first aspect, the second implementation manner of the first aspect, or the third implementation manner of the first aspect, in a fourth implementation manner of the first aspect, before the obtaining, according to a preset age model, an estimated age value that matches the facial feature of the user, the method further includes:

determining whether an estimated user age value corresponding to the facial feature of the user is saved;

when it is determined that the estimated user age value corresponding to the facial feature of the user is saved, loading the preset user interface into the terminal according to the saved estimated age value corresponding to the facial feature of the user; and

only when it is determined that the estimated user age value corresponding to the facial feature of the user is not saved, obtaining, according to the preset age model, the estimated age value that matches the facial feature of the user.

With reference to the first aspect, the first implementation manner of the first aspect, the second implementation manner of the first aspect, the third implementation manner of the first aspect, or the fourth implementation manner of the first aspect, in a fifth implementation manner of the first aspect, after the obtaining, according to a preset age model, an estimated age value that matches the facial feature of the user, the method further includes:

saving a correspondence between the facial feature of the user and the obtained estimated age value.

According to a second aspect, an embodiment of the present invention discloses a terminal, where the terminal includes:

a camera, configured to obtain an image that includes a facial feature of a user;

an extracting unit, configured to extract the facial feature of the user from the image obtained by the camera;

an obtaining unit, configured to obtain, according to a preset age model, an estimated age value that matches the facial feature of the user extracted by the extracting unit; and

a loading unit, configured to load a preset user interface into the terminal according to the estimated age value obtained by the obtaining unit.

With reference to the second aspect, in a first implementation manner of the second aspect, the loading unit is specifically configured to:

obtain, according to the estimated age value obtained by the obtaining unit, a configuration solution that is of the preset user interface and matches the estimated age value; and load the preset user interface into the terminal according to the configuration solution of the preset user interface.

With reference to the second aspect or the first implementation manner of the second aspect, in a second implementation manner of the second aspect, the terminal further includes a locating unit, where:

the locating unit divides the image obtained by the camera into blocks and performs facial detection on different blocks to determine a position of a face; and

the extracting unit extracts the facial feature of the user from the position of the face, where the facial feature of the user is used for performing age estimation.

With reference to the second aspect, the first implementation manner of the second aspect, or the second implementation manner of the second aspect, in a third implementation manner of the second aspect, the terminal further includes a microphone, where:

the microphone is specifically configured to:

collect a voice of the user;

the extracting unit is further configured to:

extract a feature of the voice collected by the microphone; and

the obtaining unit is specifically configured to:

obtain, according to the preset age model, an estimated age value that matches the facial feature of the user and the feature of the voice of the user that are extracted by the extracting unit.

With reference to the second aspect, the first implementation manner of the second aspect, the second implementation manner of the second aspect, or the third implementation manner of the second aspect, in a fourth implementation manner of the second aspect, the terminal further includes a determining unit, where:

the determining unit is configured to determine whether an estimated user age value corresponding to the facial feature of the user extracted by the extracting unit is saved;

when the determining unit determines that the estimated user age value corresponding to the facial feature of the user is saved, the loading unit loads the preset user interface into the terminal according to the saved estimated age value corresponding to the facial feature of the user; and

the obtaining unit is specifically configured to:

only when the determining unit determines that the estimated user age value corresponding to the facial feature of the user is not saved, obtain, according to the preset age model, the estimated age value that matches the facial feature of the user.

With reference to the second aspect, the first implementation manner of the second aspect, the second implementation manner of the second aspect, the third implementation manner of the second aspect, or the fourth implementation manner of the second aspect, in a fifth implementation manner of the second aspect, the terminal further includes a saving unit, where:

the obtaining unit obtains, according to the preset age model, the estimated age value that matches the facial feature of the user; and

the saving unit saves a correspondence between the facial feature of the user extracted by the extracting unit and the estimated age value obtained by the obtaining unit.

It can be learned from the foregoing that, according to a terminal configuration method provided in an embodiment of the present invention, a terminal obtains an image of a facial feature of a user, obtains an estimated age value of the user according to the facial feature of the user in the image, and loads a preset user interface into the terminal according to an age of the user, which makes the user convenient to use the terminal and enhances user experience. Further, the terminal may further obtain a more accurate estimated age value by using the facial feature of the user and a feature of a voice of the user so that the preset user interface is loaded into the terminal according to the estimated age value, which provides a more proper configuration for the user and enhances user experience.

An embodiment of the present invention provides another terminal configuration method and another terminal, which may make a user convenience to use a terminal.

According to a first aspect, an embodiment of the present invention discloses another terminal configuration method and another terminal, where the method includes:

collecting a voice of a user;

extracting a feature of the voice;

obtaining, according to a preset age model, an estimated age value that matches the feature of the voice; and

loading a preset user interface into the terminal according to the estimated age value.

With reference to the first aspect, in a first possible implementation manner of the first aspect, the loading a preset user interface into the terminal according to the estimated age value includes:

obtaining, according to the estimated age value, a configuration solution that is of the preset user interface and matches the estimated age value; and

loading the preset user interface into the terminal according to the configuration solution of the preset user interface.

With reference to the first aspect or the first implementation manner of the first aspect, in a second implementation manner of the first aspect, the extracting a feature of the voice includes:

extracting a Mel frequency cepstrum coefficient MFCC of the voice and using the MFCC as the feature of the voice of the user.

With reference to the first aspect, the first implementation manner of the first aspect, or the second implementation manner of the first aspect, in a third implementation manner of the first aspect, before the obtaining, according to a preset age model, an estimated age value that matches a facial feature of the user, the method further includes:

determining whether an estimated user age value corresponding to the feature of the voice is saved;

when it is determined that the estimated user age value corresponding to the feature of the voice is saved, loading the preset user interface into the terminal according to the saved estimated age value corresponding to the feature of the voice; and

only when it is determined that the estimated user age value corresponding to the feature of the voice is not saved, obtaining, according to the preset age model, the estimated age value that matches the feature of the voice.

With reference to the first aspect, the first implementation manner of the first aspect, the second implementation manner of the first aspect, or the third implementation manner of the first aspect, in a fourth implementation manner of the first aspect, after the obtaining an estimated age value that matches the feature of the voice, the method further includes:

saving a correspondence between the feature of the voice and the obtained estimated age value.

According to a second aspect, an embodiment of the present invention discloses a terminal, where the terminal includes a microphone, configured to collect a voice of a user;

an extracting unit, configured to extract a feature of the voice of the user collected by the microphone;

an obtaining unit, configured to obtain, according to a preset age model, an estimated age value that matches the feature of the voice extracted by the extracting unit; and

a loading unit, configured to load a preset user interface into the terminal according to the estimated age value obtained by the obtaining unit.

With reference to the second aspect, in a first implementation manner of the second aspect, the loading unit is specifically configured to:

obtain, according to the estimated age value obtained by the obtaining unit, a configuration solution that is of the preset user interface and matches the estimated age value; and load the preset user interface into the terminal according to the configuration solution of the preset user interface.

With reference to the second aspect or the first implementation manner of the second aspect, in a second implementation manner of the second aspect, the extracting unit is specifically configured to:

extract a Mel frequency cepstrum coefficient MFCC of the voice of the user collected by the microphone and use the MFCC as the feature of the voice of the user.

With reference to the second aspect, the first implementation manner of the second aspect, or the second implementation manner of the second aspect, in a third implementation manner of the second aspect, the terminal further includes a determining unit, where:

the determining unit is configured to determine whether an estimated user age value corresponding to the feature of the voice extracted by the extracting unit is saved;

when the determining unit determines that the estimated user age value corresponding to the feature of the voice is saved, the loading unit loads the preset user interface into the terminal according to the saved estimated age value corresponding to the feature of the voice; and

the obtaining unit is specifically configured to:

only when the determining unit determines that the estimated age value corresponding to the feature of the voice is not saved, obtain, according to the preset age model, the estimated age value that matches the feature of the voice.

With reference to the second aspect, the first implementation manner of the second aspect, the second implementation manner of the second aspect, or the third implementation manner of the second aspect, in a fourth implementation manner of the second aspect, the terminal further includes a saving unit, where:

the obtaining unit obtains, according to the preset age model, the estimated age value that matches the feature of the voice; and

the saving unit saves a correspondence between the feature of the voice and the estimated age value obtained by the obtaining unit.

It can be learned from the foregoing that, according to a terminal configuration method provided in another embodiment of the present invention, a terminal collects a voice of a user, obtains an estimated age value of the user by using a feature of the voice, and loads a preset user interface according to the estimated age value; and a method in which the terminal performs automatic configuration according to the voice of the user provides convenience for the user.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a terminal configuration method according to an embodiment of the present invention;

FIG. 2 is a flowchart of a terminal configuration method according to another embodiment of the present invention;

FIG. 3 is a flowchart of a terminal configuration method according to another embodiment of the present invention;

FIG. 4 is a flowchart of a terminal configuration method according to another embodiment of the present invention;

FIG. 5 is a flowchart of a terminal configuration method according to another embodiment of the present invention;

FIG. 6 is a flowchart of a terminal configuration method according to another embodiment of the present invention;

FIG. 7 is a structural diagram of a terminal according to an embodiment of the present invention;

FIG. 8 is a structural diagram of a terminal according to another embodiment of the present invention;

FIG. 9 is a structural diagram of a terminal according to another embodiment of the present invention;

FIG. 10 is a structural diagram of a terminal according to another embodiment of the present invention;

FIG. 11 is a structural diagram of a terminal according to another embodiment of the present invention; and

FIG. 12 is a structural diagram of a terminal according to another embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

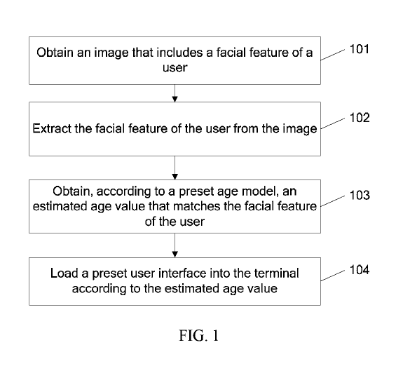

The following describes a terminal configuration method in an embodiment of the present invention according to FIG. 1. The method describes a process in which a terminal obtains an image that includes a facial feature of a user, obtains an estimated age value according to the facial feature of the user, and performs automatic configuration. The method specifically includes:

101. Obtain an image that includes a facial feature of a user.

When the user starts or unlocks a terminal, a photographing apparatus of the terminal automatically starts and takes a facial photo to obtain an image that includes a facial feature of the user. The facial feature of the user usually includes areas surrounding eyes and a nose, a forehead area, and the like. The terminal may be a smartphone, a tablet computer, a notebook computer or the like. The photographing apparatus may be a camera or the like.

102. Extract the facial feature of the user from the image.

The obtained image that includes the facial feature of the user is divided into blocks, facial detection is performed on different blocks, and a position of a face may be determined by means of the detection. Then matching is performed by using a point distribution model on the face whose position is determined, key points of the face are marked, and the face is divided into several triangle areas by using these key points. Image data in different areas is transformed, by using local binary patterns LBPs, to obtain texture features. After transformation by using the LBPs, a value corresponding to a smooth area is smaller, otherwise, a value corresponding to a rough area is greater. These features in different areas form a value vector, and the value vector is used to represent the facial feature that is of the user and included in the image.

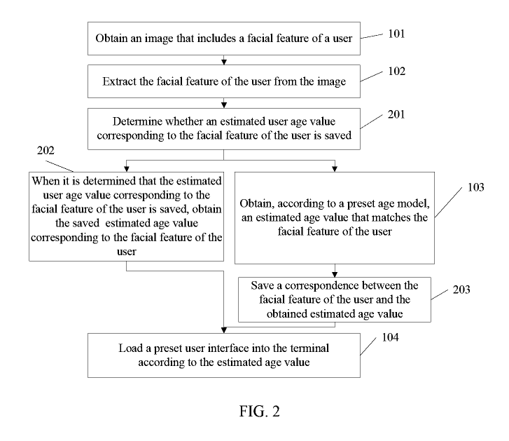

Optionally, as shown in FIG. 2, the method includes step 201: Determine whether an estimated user age value corresponding to the facial feature of the user is saved; and step 202: When it is determined that the estimated user age value corresponding to the facial feature of the user is saved, obtain the saved estimated age value corresponding to the facial feature of the user, and proceed to 104; and when it is determined that the estimated user age value corresponding to the facial feature of the user is not saved, proceed to 103.

103. Obtain, according to a preset age model, an estimated age value that matches the facial feature of the user.

The value vector representing the facial feature of the user is input in the preset age model, and the estimated age value that matches the facial feature of the user is obtained by means of calculation. The value vector representing the facial feature of the user may be input in the preset age model by using a support vector machine (Support Vector Machine, SVM) algorithm, a neural network algorithm, or the like.

The preset age model is internally set in the terminal and may be obtained by training. Training the preset age model includes: collecting a large amount of facial image data having an age marker; obtaining a feature vector of the image by preprocessing the image and extracting a feature; and training the obtained feature vector and a corresponding age, so that an image age identification model is obtained, and a corresponding age can be obtained according to an input feature vector.

Optionally, as shown in FIG. 2, the method includes step 203: Save a correspondence between the facial feature of the user and the obtained estimated age value.

104. Load a preset user interface into the terminal according to the estimated age value.

The obtained estimated age value is input in a preset function configuration database to perform matching, to obtain a configuration solution that is of the preset user interface and corresponds to the estimated age value. A function recorded in the solution is loaded according to the obtained configuration solution of the preset user interface, so that a setting of the terminal is completed. The configuration solution of the preset user interface may include functions such as a character size setting, an image or icon size setting, default volume, voice broadcast, and a function of enabling position tracking.

It can be learned from the foregoing that, according to a terminal configuration method provided in an embodiment of the present invention, an estimated age value of a user is determined by automatically obtaining an image that includes a facial feature of the user, and a preset user interface is loaded into a terminal according to the estimated age value of the user, which makes the user convenient to use the terminal and enhances user experience.

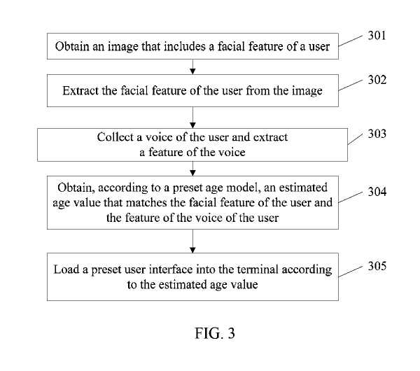

As shown in FIG. 3, a terminal configuration method according to another embodiment of the present invention is described.

301. Obtain an image that includes a facial feature of a user.

When the user starts or unlocks a terminal, a photographing apparatus of the terminal automatically starts and takes a facial photo to obtain an image that includes a facial feature of the user. The facial feature of the user usually includes areas surrounding eyes and a nose, a forehead area, and the like. The terminal may be a smartphone, a tablet computer, a notebook computer or the like. The photographing apparatus may be a camera or the like.

302. Extract the facial feature of the user from the image.

The obtained image that includes the facial feature of the user is divided into blocks, facial detection is performed on different blocks, and a position of a face may be determined by means of the detection. Then matching is performed by using a point distribution model on the face whose position is determined, key points of the face are marked, and the face is divided into several triangle areas by using these key points. Image data in different areas is transformed, by using local binary patterns LBPs, to obtain texture features. After transformation by using the LBPs, a value corresponding to a smooth area is smaller, otherwise, a value corresponding to a rough area is greater. These features in different areas form a value vector, and the value vector is used to represent the facial feature that is of the user and included in the image.

303. Collect a voice of the user and extract a feature of the voice.

A piece of voice of the user is obtained by using a voice collecting device, and a Mel frequency cepstrum coefficient (Mel Frequency Cepstrum Coefficient, MFCC) of this piece of voice data is extracted and used as the feature of the voice of the user.

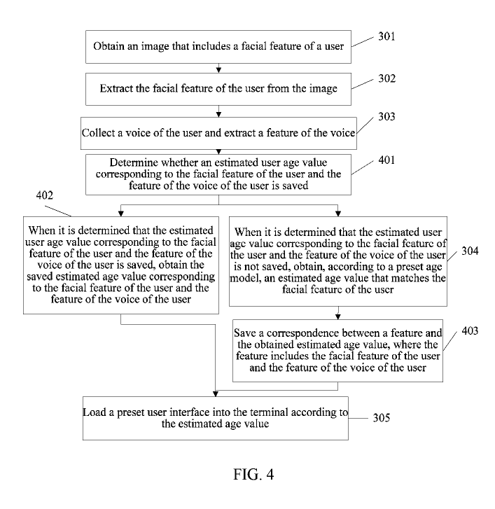

Optionally, as shown in FIG. 4, the method further includes step 401: Determine whether an estimated user age value corresponding to the facial feature of the user and the feature of the voice of the user is saved; and step 402: When it is determined that the estimated user age value corresponding to the facial feature of the user and the feature of the voice of the user is saved, obtain the saved estimated age value corresponding to the facial feature of the user and the feature of the voice of the user; and when it is determined that the estimated user age value corresponding to the facial feature of the user and the feature of the voice of the user is not saved, proceed to 304.

304. Obtain, according to a preset age model, an estimated age value that matches the facial feature of the user and the feature of the voice of the user.

The value vector representing the facial feature of the user and a voice feature parameter of the user, for example a value vector representing the feature of the voice of the user, are input in the preset age model, and the estimated age value that matches the facial feature of the user is obtained by means of calculation. The value vector representing the facial feature of the user may be input in the preset age model by using an SVM algorithm, a neural network algorithm or the like.

The preset age model is internally set in the terminal and is obtained by training facial image data and voice feature data. A corresponding age may be obtained according to the input vector of the facial feature of the user and the voice feature parameter of the user, that is the value vector representing the facial feature of the user and the value vector representing the feature of the voice.

Optionally, as shown in FIG. 4, the method further includes step 403: Save a correspondence between a feature and the obtained estimated age value, where the feature includes the facial feature of the user and the feature of the voice of the user.

305. Load a preset user interface into the terminal according to the estimated age value.

The estimated age value is input in a preset function configuration database to perform matching, to obtain a configuration solution that is of the preset user interface and corresponds to the estimated age value. A function recorded in a list is loaded according to the obtained configuration solution of the preset user interface, so that a setting of the terminal is completed. A function configuration list may include functions such as a character size setting, an image or icon size setting, default volume, voice broadcast, and a function of enabling position tracking.

It can be learned from the foregoing that, according to a terminal configuration method provided in an embodiment of the present invention, an estimated age value of a user is determined by obtaining a facial feature of the user and a feature of a voice of the user, and a preset user interface is loaded into a terminal according to the estimated age value of the user, which makes the user convenient to use the terminal and enhances user experience.

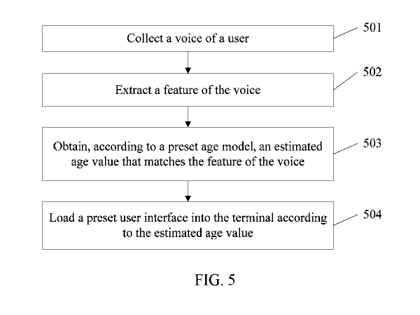

As shown in FIG. 5, a terminal configuration method according to another embodiment of the present invention is described.

501. Collect a voice of a user.

When the user starts or unlocks a terminal, a voice collecting apparatus of the terminal automatically starts and may collect a voice of the user as long as the user speaks.

502. Extract a feature of the voice.

A piece of voice of the user is obtained by using a voice collecting device, an MFCC of this piece of voice data is extracted and used as the feature of the voice of the user.

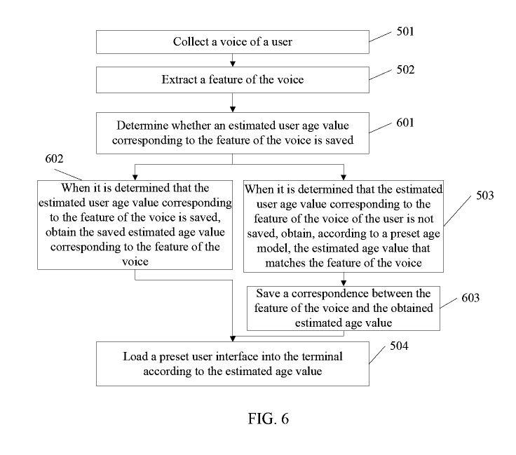

Optionally, as shown in FIG. 6, the method further includes step 601: Determine whether an estimated user age value corresponding to the feature of the voice is saved; and step 602: When it is determined that the estimated user age value corresponding to the feature of the voice is saved, obtain the saved estimated age value corresponding to the feature of the voice; and when it is determined that the estimated user age value corresponding to the feature of the voice is not saved, proceed to 503.

503. Obtain, according to a preset age model, an estimated age value that matches the feature of the voice.

A parameter representing the feature of the voice of the user is input in the preset age model, and the estimated age value that matches the feature of the voice of the user is obtained by means of calculation. A value vector representing the facial feature of the user is input in the preset age model by using an SVM algorithm, a neural network algorithm or the like.

The preset age model is internally set in the terminal and is obtained by training data of the feature of the voice. A corresponding age may be obtained from the preset age model according to the input voice feature parameter of the user.

Optionally, as shown in FIG. 6, the method further includes step 603: Save a correspondence between the feature of the voice and the obtained estimated age value.

504. Load a preset user interface into the terminal according to the estimated age value.

The estimated age value is input in a preset function configuration database to perform matching, to obtain a configuration solution that is of the preset user interface and corresponds to the estimated age value. A function recorded in a list is loaded according to the obtained configuration solution of the preset user interface, so that a setting of the terminal is completed. A function configuration list may include functions such as a character size setting, an image or icon size setting, default volume, voice broadcast, and a function of enabling position tracking.

It can be learned from the foregoing that, according to a terminal configuration method provided in an embodiment of the present invention, an estimated age value of a user is determined by using a feature of a voice of the user, and a preset user interface is loaded into a terminal according to the estimated age value of the user, which makes the user convenient to use the terminal and enhances user experience.

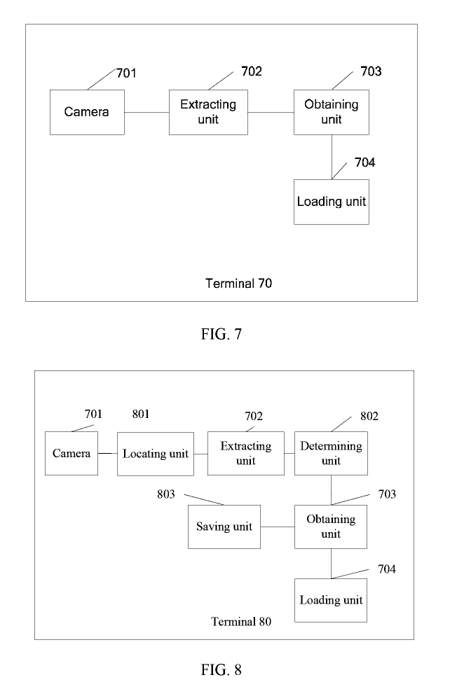

The following describes a terminal 70 in an embodiment of the present invention according to FIG. 7, and as shown in FIG. 7, the apparatus 70 includes:

a camera 701, an extracting unit 702, an obtaining unit 703, and a loading unit 704.

The camera 701 is configured to obtain an image that includes a facial feature of a user.

When the user starts or unlocks the terminal, the camera 701 may take a facial photo to obtain an image that includes a facial feature of the user. The facial feature of the user usually includes areas surrounding eyes and a nose, a forehead area, and the like.

Optionally, as shown in FIG. 8, the terminal further includes a locating unit 801, configured to divide the image that includes the facial feature of the user and is obtained by the camera 701 into blocks, perform facial detection on different blocks, and determine a position of a face by means of the detection.

The extracting unit 702 is configured to extract the facial feature of the user from the image obtained by the camera 701.

The extracting unit 702 performs matching on the face by using a point distribution model, marks key points of the face, divides the face into several triangle areas by using these key points, and transforms image data in different areas, by using local binary patterns LBPs, to obtain texture features. After transformation by using the LBPs, a value corresponding to a smooth area is smaller, otherwise, a value corresponding to a rough area is greater. These features in different areas form a value vector, and the extracting unit 702 uses the value vector to represent the facial feature that is of the user and included in the image.

Optionally, as shown in FIG. 8, the apparatus further includes a determining unit 802, configured to determine whether an estimated user age value corresponding to the facial feature of the user extracted by the extracting unit 702 is saved. When it is determined that the estimated user age value corresponding to the facial feature of the user is saved, the obtaining unit 703 obtains the saved estimated age value corresponding to the facial feature of the user; and only when it is determined that the estimated user age value corresponding to the facial feature of the user extracted by the extracting unit 702 is not saved, the obtaining unit 703 obtains, according to a preset age model, an estimated age value that matches the facial feature of the user.

The obtaining unit 703 is configured to obtain, according to the preset age model, the estimated age value that matches the facial feature of the user extracted by the extracting unit 702.

The obtaining unit 703 inputs, in the preset age model, a value vector representing the facial feature of the user extracted by the extracting unit 702, and obtains, by means of calculation, the estimated age value that matches the facial feature of the user. The value vector representing the facial feature of the user may be input in the preset age model by using a support vector machine (Support Vector Machine, SVM) algorithm, a neural network algorithm, or the like.

The preset age model is internally set in the terminal and may be obtained by training. Training the preset age model includes: collecting a large amount of facial image data having an age marker; obtaining a feature vector of the image by preprocessing the image and extracting a feature; and training the obtained feature vector and a corresponding age, so that an image age identification model is obtained, and a corresponding age can be obtained according to an input feature vector.

Optionally, as shown in FIG. 8, the terminal further includes a saving unit 803, configured to save a correspondence between the facial feature of the user and the estimated age value obtained by the obtaining unit 703.

The loading unit 704 is configured to load a preset user interface into the terminal according to the estimated age value obtained by the obtaining unit 703.

The loading unit 704 inputs the estimated age value obtained by the obtaining unit 703 in a preset function configuration database to perform matching, to obtain a configuration solution that is of the preset user interface and corresponds to the estimated age value. A function recorded in the solution is loaded according to the obtained configuration solution of the preset user interface, so that a setting of the terminal is completed. The configuration solution of the preset user interface may include functions such as a character size setting, an image or icon size setting, default volume, voice broadcast, and a function of enabling position tracking.

It can be learned from the foregoing that, according to a terminal provided in an embodiment of the present invention, an estimated age value of a user is determined by automatically obtaining an image that includes a facial feature of the user, and a preset user interface is loaded into a terminal according to the estimated age value of the user, which makes the user convenient to use the terminal and enhances user experience.

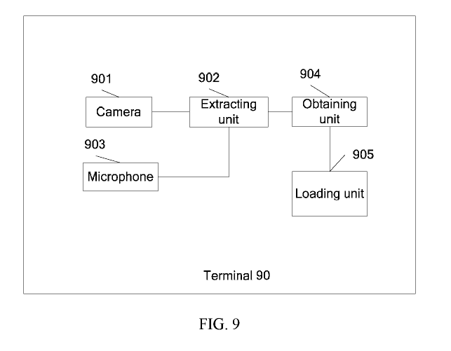

The following describes a terminal 90 in an embodiment of the present invention according to FIG. 9, and as shown in FIG. 9, the apparatus 90 includes:

a camera 901, an extracting unit 902, a microphone 903, an obtaining unit 904, and a loading unit 905.

The camera 901 is configured to obtain an image that includes a facial feature of a user.

When the user starts or unlocks the terminal, the camera 901 may take a facial photo to obtain an image that includes a facial feature of the user. The facial feature of the user usually includes areas surrounding eyes and a nose, a forehead area, and the like.

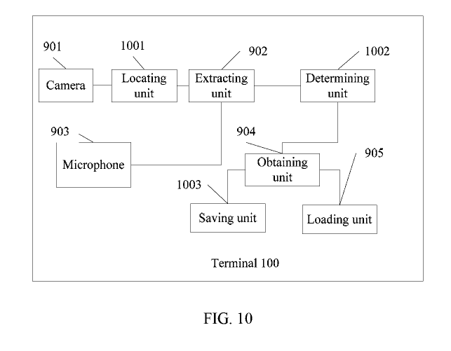

Optionally, as shown in FIG. 10, the terminal further includes a locating unit 1001, configured to divide the image that includes the facial feature of the user and is obtained by the camera 901 into blocks, perform facial detection on different blocks, and determine a position of a face by means of the detection.

The extracting unit 902 is configured to extract the facial feature of the user from the image obtained by the camera 901.

The extracting unit 902 performs matching, by using a point distribution model, on the face whose position is determined, marks key points of the face, divides the face into several triangle areas by using these key points, and transforms image data in different areas, by using local binary patterns LBPs, to obtain texture features. After transformation by using the LBPs, a value corresponding to a smooth area is smaller, otherwise, a value corresponding to a rough area is greater. These features in different areas form a value vector, and the extracting unit 902 uses the value vector to represent the facial feature that is of the user and included in the image.

The microphone 903 is configured to collect a voice of the user and the extracting unit 902 is configured to extract a feature of the voice.

The microphone 903 obtains a piece of voice of the user by using a voice collecting device. The extracting unit 902 extracts a Mel frequency cepstrum coefficient (Mel Frequency Cepstrum Coefficient, MFCC) of this piece of voice data and uses the coefficient as the feature of the voice of the user.

Optionally, as shown in FIG. 10, the terminal further includes a determining unit 1002, configured to determine whether an estimated user age value corresponding to the facial feature of the user and the feature of the voice of the user is saved. When it is determined that the estimated user age value corresponding to the facial feature of the user and the feature of the voice of the user is saved, the obtaining unit 904 obtains the saved estimated age value corresponding to the facial feature of the user and the feature of the voice of the user; and only when it is determined that the estimated age value corresponding to the facial feature of the user and the feature of the voice of the user is not saved, the obtaining unit 904 obtains an estimated age value that matches the facial feature of the user and the feature of the voice of the user.

The obtaining unit 904 is configured to obtain, according to a preset age model, the estimated age value that matches the facial feature of the user extracted by the extracting unit 902.

The obtaining unit 904 inputs, in the preset age model, a value vector representing the facial feature of the user extracted by the extracting unit 902, and obtains, by means of calculation, the estimated age value that matches the facial feature of the user. The value vector representing the facial feature of the user may be input in the preset age model by using a support vector machine (Support Vector Machine, SVM) algorithm, a neural network algorithm, or the like.

The preset age model is internally set in the terminal and may be obtained by training. Training the preset age model includes: collecting a large amount of facial image data having an age marker; obtaining a feature vector of the image by preprocessing the image and extracting a feature; and training the obtained feature vector and a corresponding age, so that an image age identification model is obtained, and a corresponding age can be obtained according to an input feature vector.

Optionally, as shown in FIG. 10, the terminal further includes a saving unit 1003, configured to save a correspondence between a feature and the obtained estimated age value, where the feature includes the facial feature of the user and the feature of the voice of the user.

The loading unit 905 is configured to load a preset user interface into the terminal according to the estimated age value obtained by the obtaining unit 904.

The loading unit 905 inputs the estimated age value obtained by the obtaining unit 904 in a preset function configuration database to perform matching, to obtain a configuration solution that is of the preset user interface and corresponds to the estimated age value. A function recorded in the solution is loaded according to the obtained configuration solution of the preset user interface, so that a setting of the terminal is completed. The configuration solution of the preset user interface may include functions such as a character size setting, an image or icon size setting, default volume, voice broadcast, and a function of enabling position tracking.

It can be learned from the foregoing that, according to a terminal provided in an embodiment of the present invention, an age of a user is determined by using a facial feature of the user and a feature of a voice of the user, and a preset user interface is loaded into a terminal according to the age of the user, which makes the user convenient to use the terminal and enhances user experience.

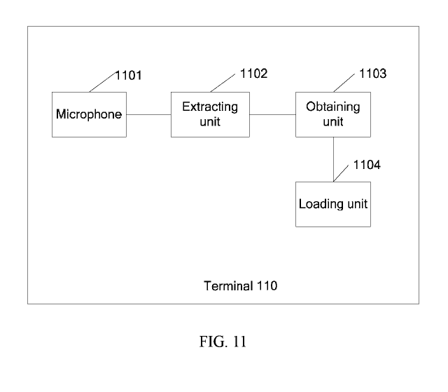

The following describes a terminal configuration apparatus 110 in an embodiment of the present invention according to FIG. 11, and as shown in FIG. 11, the apparatus 110 includes:

a microphone 1101, an extracting unit 1102, an obtaining unit 1103, and a loading unit 1104.

The microphone 1101 is configured to collect a voice of a user.

When a terminal is started or is unlocked, the microphone 1101 obtains a piece of voice of the user by using a voice collecting device.

The extracting unit 1102 is configured to extract a feature of the voice of the user collected by the microphone 1101.

The extracting unit 1102 extracts a Mel frequency cepstrum coefficient (Mel Frequency Cepstrum Coefficient, MFCC) of this piece of voice data collected by the collecting unit 1102, and uses the coefficient as the feature of the voice of the user.

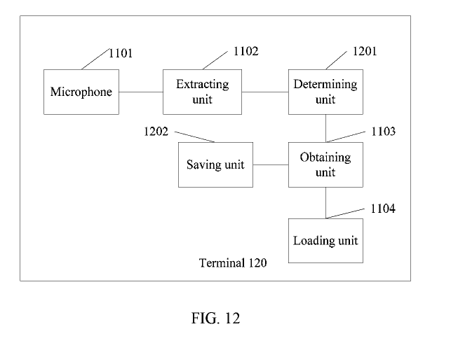

Optionally, as shown in FIG. 12, the terminal further includes a determining unit 1201, configured to determine whether an estimated user age value corresponding to the feature of the voice extracted by the extracting unit 1102 is saved. When it is determined that the estimated user age value corresponding to the feature of the voice is saved, the obtaining unit 1103 obtains the saved estimated age value corresponding to the feature of the voice; and only when it is determined that the estimated user age value corresponding to the feature of the voice extracted by the extracting unit 1102 is not saved, the obtaining unit 1103 obtains, according to a preset age model, an estimated age value that matches the feature of the voice of the user.

The obtaining unit 1103 is configured to obtain, according to the preset age model, the estimated age value that matches the feature of the voice extracted by the extracting unit 1102.

The obtaining unit 1103 inputs, by using a support vector machine (Support Vector Machine, SVM) algorithm, a neural network algorithm or the like, the MFCC representing the feature of the voice of the user in the preset age model, and obtains, by means of calculation, the estimated age value that matches the feature of the voice of the user.

The preset age model is internally set in the terminal and obtained by training. Training the preset age model includes: collecting a large amount of voice data having an age marker; obtaining an MFCC of the voice by preprocessing the voice and extracting a feature; and training the obtained MFCC and a corresponding age by using a machine learning algorithm such as the SVM algorithm or the neural network algorithm, so that a preset age identification model is obtained and a corresponding age can be obtained according to an input MFCC.

Optionally, as shown in FIG. 12, the terminal further includes a saving unit 1202, configured to save a correspondence between the feature of the voice and the estimated age value obtained by the obtaining unit 1103.

The loading unit 1104 is configured to load a preset user interface into the terminal according to the estimated age value obtained by the obtaining unit 1103.

The loading unit 1104 inputs the estimated age value obtained by the obtaining unit 1103 in a preset function configuration database to perform matching, to obtain a configuration solution that is of the preset user interface and corresponds to the estimated age value. A function recorded in the solution is loaded according to the obtained configuration solution of the preset user interface, so that a setting of the terminal is completed. The configuration solution of the preset user interface may include functions such as a character size setting, an image or icon size setting, default volume, voice broadcast, and a function of enabling position tracking.

It can be learned from the foregoing that, according to a terminal provided in an embodiment of the present invention, an estimated age value of a user is determined by collecting a feature of a voice of the user, and a preset user interface is loaded according to the estimated age value of the user, which makes the user convenient to use the terminal and enhances user experience.

It should be noted that, for brief description, the foregoing method embodiments are represented as a series of actions. However, a person skilled in the art should appreciate that the present invention is not limited to the described sequence of the actions, because according to the present invention, some steps may be performed in another sequence or simultaneously. Next, it should be further appreciated by a person skilled in the art that the embodiments described in this specification all belong to exemplary embodiments, and the involved actions and modules are not necessarily required by the present invention.

Because content, such as information exchange and a performing process between modules in the foregoing apparatuses and systems, and that in the method embodiments of the present invention are based on a same conception, for detailed content, reference may be made to the descriptions in the method embodiments of the present invention, and no further details are provided herein.

A person of ordinary skill in the art may understand that all or a part of the processes of the methods in the embodiments may be implemented by a computer program instructing relevant hardware. The program may be stored in a computer readable storage medium. When the program runs, the processes of the methods in the embodiments are performed. The foregoing storage medium may include: a magnetic disk, an optical disc, a read-only memory (ROM: Read-Only Memory), or a random access memory (RAM: Random Access Memory).

Specific examples are used in this specification to describe the principle and implementation manners of the present invention. The descriptions of the foregoing embodiments are merely intended to help understand the method and ideas of the present invention. In addition, with respect to the implementation manners and the application scope, modifications may be made by a person of ordinary skill in the art according to the ideas of the present invention. In conclusion, content of this specification shall not be construed as a limitation on the present invention.

1. A terminal configuration method, comprising:
obtaining, by a terminal, an image of a user;
extracting, by the terminal, a facial feature of the user from the obtained image;
determining, by the terminal, based on the extracted facial feature and a preset age model, an estimated age of the user; and
loading, by the terminal, a preset user interface based on the determined estimated age.

2. (canceled)

3. The method according to claim 1, further comprising:
dividing the obtained image into blocks and performing facial detection on the blocks.

4. The method according to claim 1, further comprising:
obtaining voice information corresponding to the user and extracting a voice feature from the voice information;
wherein determining the estimated age of the user is further based on the extracted voice feature.

5. The method according to claim 1, further comprising:
determining whether a previously estimated age of the user is saved;
wherein determining the estimated age of the user is in response to determining that no previously estimated age of the user is saved.

6. The method according to claim 1, further comprising:
saving a correspondence between the facial feature of the user and the estimated age of the user.

7. A terminal configuration method, comprising:
obtaining, by a terminal, voice information corresponding to a user;
extracting, by the terminal, a voice feature from the voice information;
determining, based on the extracted voice feature and a preset age model, an estimated age of the user; and
loading, by the terminal, a preset user interface based on the determined estimated age.

8. (canceled)

9. The method according to claim 7, wherein a Mel frequency cepstrum coefficient (MFCC) corresponding to the voice information is the extracted voice feature.

10. The method according to claim 7, further comprising:
determining whether a previously estimated age of the user is saved;
wherein determining the estimated age of the user is in response to determining that no previously estimated age of the user is saved.

11. The method according to claim 7, further comprising:
saving a correspondence between the voice feature corresponding to the user and the estimated age of the user.

12. A terminal, comprising:
a camera, configured to obtain an image of a user; and
a processor, configured to extract a facial feature of the user from the obtained image to determine, based on the extracted facial feature and a preset age model, an estimated age of the user; and to load a preset user interface for the terminal based on the determined estimated age.

13. (canceled)

14. The terminal according to claim 12, wherein the processor is further configured to divide the obtained image into blocks and perform facial detection on the blocks.

15. The terminal according to claim 12, further comprising a microphone, configured to obtain voice information corresponding to the user;
wherein the processor is further configured to: extract a voice feature from the obtained voice information; and
wherein the determination of the estimated age is further based on the extracted voice feature.

16. The terminal according to claim 12, wherein the processor is further configured to determine whether an estimated age of the user is previously saved;
wherein the processor being configured to determine, based on the extracted facial features and a preset age model, an estimated age of the user and to load a preset user interface for the terminal based on the determined estimated age further comprises: the processor being configured, based on the estimated age of the user not being previously saved, to determine, based on the extracted facial features and a preset age model, an estimated age of the user and to load a preset user interface for the terminal based on the determined estimated age.

17. The terminal according to claim 12, wherein the processor is further configured to cause a correspondence between the facial features of the user and the estimated age of the user to be saved.

18. A terminal, comprising:
a microphone, configured to obtain voice information corresponding to a user;
a processor, configured to extract a voice feature from the voice information; to determine, based on the extracted voice feature and a preset age model, an estimated age of the user; and to load a preset user interface for the terminal based on the determined estimated age.

19. (canceled)

20. The terminal according to claim 18, wherein a Mel frequency cepstrum coefficient (MFCC) corresponding to the voice information of the user is the extracted feature of the voice of the user.

21. The terminal according to claim 18, wherein the processor is further configured to determine whether an estimated user age of the user is saved;
wherein the processor being configured to determine, based on the extracted voice feature and a preset age model, an estimated age of the user; and to load a preset user interface for the terminal based on the determined estimated age further comprises: the processor being configured, based on the estimated age of the user not being previously saved, to determine, based on the extracted voice feature and a preset age model, an estimated age of the user and to load a preset user interface for the terminal based on the determined estimated age.

22. The terminal according to claim 18, wherein the processor is further configured to cause a correspondence between the voice feature corresponding of the user and the estimated age of the user to be saved.
